(19) United States
(12) Patent Application Publication
(10) Pub. No.: US 2005/0088984 A1
(43) Pub. Date: Apr. 28, 2005

(54) METHOD FOR VIDEO DATA TRANSMISSION IN A WIRELESS NETWORK

(76) Inventors: Yi-Lon Chin, Taipei Hsien (TW); Chang-Hung Lee, Yun-Lin Hsien (TW); Cheng-Te Tseng, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,082

(22) Filed: Oct. 22, 2004

(30) Foreign Application Priority Data
Oct. 24, 2003 (TW) 092129680

(51) Int. Cl. H04Q 7/00

(52) U.S. Cl. 370/313

(57) ABSTRACT

A method for video data transmission in a wireless network. The wireless network includes a receiver for receiving a plurality of image bit-stream data. The method includes utilizing the receiver to determine if a first header in the plurality of image bit-stream data is received, and then utilizing the receiver to determine a default deader to be operated as the first header if the receiver does not receive the first header.

### BACKGROUND OF INVENTION

1. Field of the Invention

The invention relates to a method for transmitting image signals in a wireless network, and more particularly, to a method for utilizing a default header and a default frame data in a receiver when the transmission is interrupted.

2. Description of the Prior Art

In the information era, wireless communication for various digital information is already a part of daily life. Under this tendency, all mobile phones, personal digital assistants (PDA), computers and information apparatuses (IA), emphasize the ability of digital information communications. Therefore, the research and development of wireless communication modules becomes an important part of the information industry. The wireless communication technology facilitates portable or mobile networking. For instance, if wireless LAN is available to a notebook computer, a user could access to the Internet from nearly anywhere, even when the user is in motion (as in a moving car). The user could access the Internet via wireless hook-up, thus greatly boosting his productivity.

Similar with the wiring network, the wireless network can be classified into WWAN, WMAN, WLAN, and WPAN according to the expanding area the data can be transmitted. No matter which structure is applied, the wiring network facilitates a similar transmission system. Please refer to FIG. 1, which is a schematic diagram of a wireless transceiver 10 showing a transmission infrastructure of a wireless network. The wireless transceiver 10 includes a transmitter (TX) 12 and a receiver (RX) 14. The transmitter 12 and the receiver 14 respectively include a transmitting antenna 13 and a receiving antenna 15. The transmitter 12 can be used to transmit signals and data to the receiver 14 via the transmitting antenna 13 by a specific wireless network, such as a WLAN in the present embodiment. The receiving antenna 15 can be used to receive the signals and data for advanced processing by the internal circuitry of the receiver 14. The content of the transmitted signals and data vary from audio signal to the present multi-media real-time information combining audio, dynamic image signals, and interacting interfaces. Nowadays, the MPEG specification has become the most popular standard for processing dynamic images and has been applied to various digital products.

Please continue to refer to FIG. 1. The receiver 14 further includes a decoder 16, which can be used to decode a plurality of image data. Regarding the image data conforming to the MPEG specification, after the receiver 14 receives the compressed first frame data (after the transmitter 12), the decoder 16 will search the related header from the received data for de-compression. Generally, the transmitted image data include a header of the first frame data for forming bit-stream image signals. The header includes preamble data, start frame delimiter data (SFD), and so on so that the decoder 16 can identify the data source, frame size, frame resolution, and quantization parameters. Therefore, the header plays an important role during the decoding operation; that is, once the header is lost during the data transmission, the decoder 16 may improperly perform a decoding operation. However, due to the communication bandwidth insufficiency and non-optimal integration among various wireless networks, the present wireless network cannot ensure the complete correctness of the data transmission and the smooth wireless data transmission of real-time dynamic video signals.

### SUMMARY OF INVENTION

It is therefore one of the objectives of the claimed invention to provide a method for previously providing a default header and a default frame data in a receiver to solve the above-mentioned problems.

In the claimed invention, a method used in a wireless network for signal transmission is disclosed, especially for transmitting image data, which conform to MPEG-1, MPEG-2, MPEG-4 specifications, and other video encoding standards. In order to ensure the decoder of the receiver can correctly determine related header data to perform decoding operations during data transmitting and decoding operations, the corresponding transmitter will repeatedly broadcast a header information packet including the desired header information, while a default header is previously provided in the receiver as the first header of the first frame data. In addition, default frame data can be also previously provided in the receiver as the first frame for the decoder. When transmission of image data fails, the default header and default frame data can maintain the operations of the receiver. Moreover, the receiver of the present invention can operate during the procedure when the transmitter delivers data without fear of data loss.

According to the claimed invention, a method for transmitting signals in a wireless network is disclosed. The wireless network comprises a receiver for receiving a plurality of image data, and the method comprises (a) utilizing the receiver to judge whether it receives a first header of the plurality of image data; and (b) after proceeding with step (a), utilizing the receiver to pick a default header as the first header if the receiver does not receive the first header.

According to the claimed invention, a method for transmitting signals in a wireless network is disclosed. The wireless network comprises a receiver for receiving a plurality of image data, and the method comprises: (a) utilizing the receiver to judge whether it receives a first frame data of the plurality of image data; and (b) after proceeding with step (a), utilizing a default frame data as the first frame data if the receiver does not receive the first frame data.

### BRIEF DESCRIPTION OF DRAWINGS

FIG. 1 is a schematic diagram of a wireless transceiver.

FIG. 2 is a flow chart of a method embodiment according to the present invention.

FIG. 3 is a flow chart of a method embodiment based on the embodiment shown in FIG. 2

FIG. 4 is a flow chart of another method embodiment according to the present invention

FIG. 5 is a flow chart of a detailed method according to the present invention.

### DETAILED DESCRIPTION

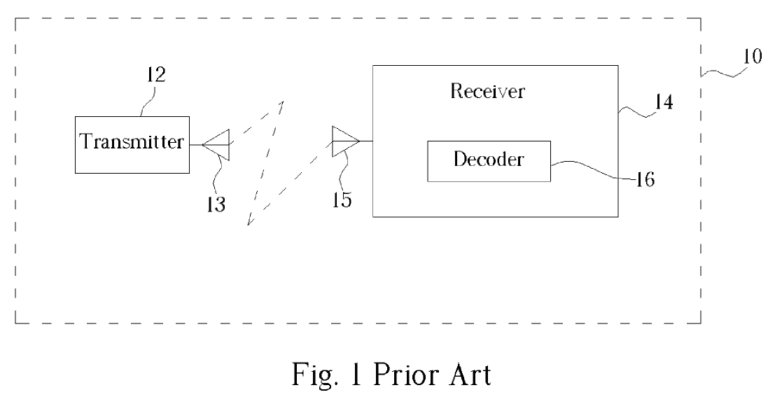

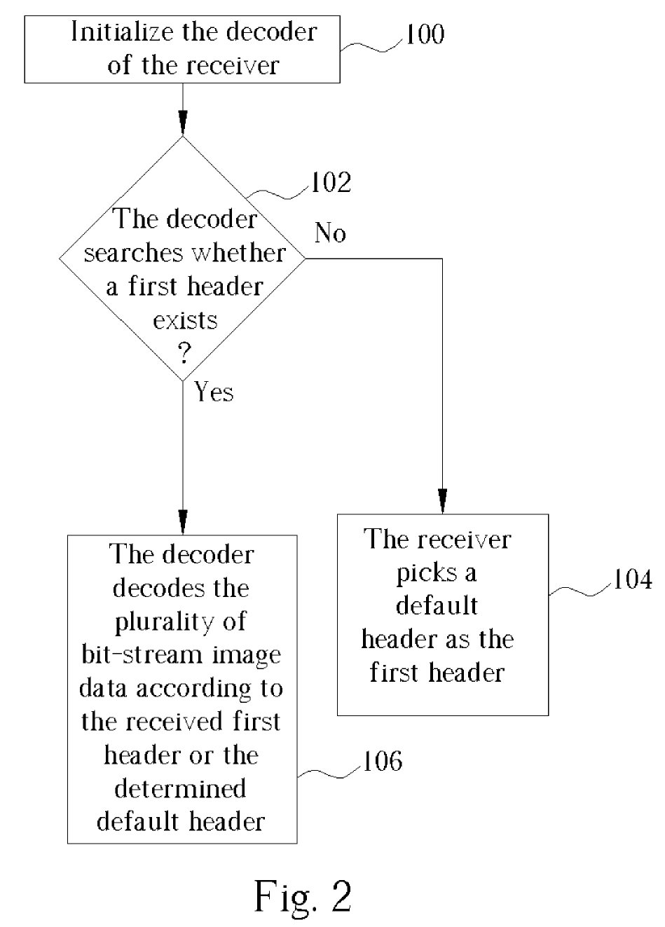

The method and structure of the present invention is based on the structure of the wireless network and the wireless transceiver 10, including the transmitter 12, the receiver 14, and the decoder 16, shown in FIG. 1. The transmitted image data conform to the MPEG specification, JPEG, and other video encoding formats. The characteristic of the present invention can be categorized into two embodiments: utilizing a default header and utilizing a default frame data. Regarding the default header, please refer to FIG. 2, which is a flow chart of a method embodiment according to the present invention. In the present embodiment, we perform the method from the viewpoint of the receiver 14 in the wireless network shown in FIG. 1, which illustrates the steps by which a plurality of image data are received. Each transmitted image data can be a video packet, which includes at least a header. Regarding the receiver 14, consecutively received image data can be treated as the bit-stream image signals. Please refer to FIG. 2:

step 100: initialize the decoder 16 of the receiver 14 shown in FIG. 1 to receive the video packet (image data) from the transmitter 12;

step 102: when the receiver 14 begins to receive the compressed first frame data, the decoder 16 of the receiver 14 will search a first header from the received data for de-compression. If the first header of the first frame data is searched, proceed with step 106; otherwise, proceed with step 104. Generally, the information contained in the first header can be used for the decoder 16 to identify the data source, the frame size, the frame resolution, and related quantization parameters (Profile).

step 104: If the decoder 16 of the receiver 14 detects that the first header is not correctly received, the receiver 14 will pick a default header as the first header. Proceed with step 106.

step 106: If the receiver 14 receives the first header, directly proceed with this step from step 102, and the decoder 16 decodes the plurality of bit-stream image data according to the received first header. If this step is executed after step 104, the decoder 16 according to the receiver 14 decodes the plurality of bit-stream image data according to the pre-determined default header.

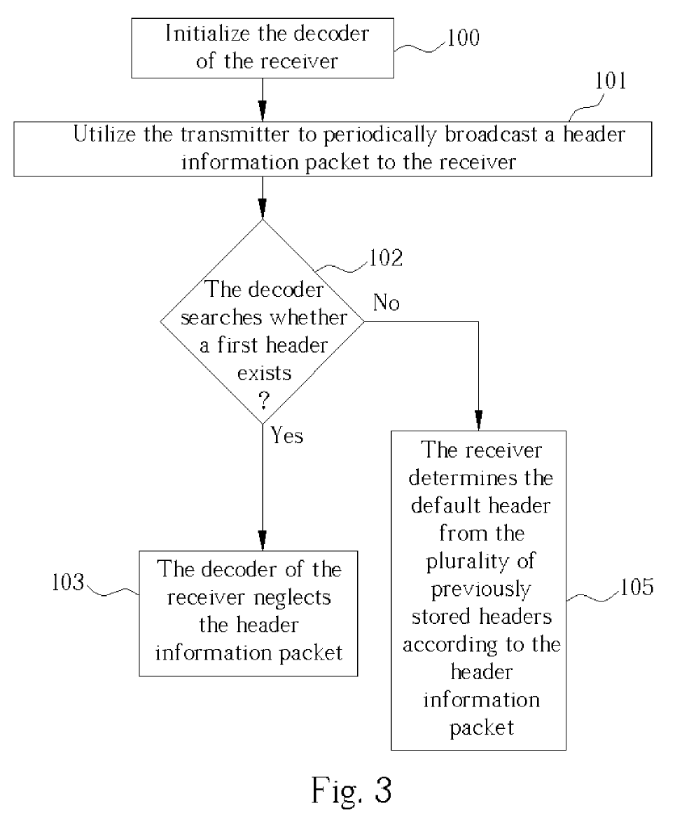

Please notice that in the present invention, in order to ensure that the decoder 16 of the receiver 14 can determine the related header for signal processing during the data transmission and decoding operation, the corresponding transmitter 12 will periodically broadcast a header information packet including related header information to the receiver 14, wherein the content of the header information packet is a text string occupying little transmission bandwidth so that the transmitter 12 can periodically broadcast the header information packet. When the receiver 14 cannot search the first header from the received data, the receiver 14 can utilize the received header information packet to pick a desired default header from a plurality of previously prepared headers. After executing the above-mentioned step 104, the plurality of headers have been previously stored in the receiver 14 so that after the receiver 14 receives the header information packet, the receiver 14 can determine the default header according to the header information packet for avoiding the decoding errors caused by the loss of the first header of the first frame data. Please refer to FIG. 3, which is a flow chart of a method embodiment based on the embodiment shown in FIG. 2 with following additional steps included:

step 101: after proceeding with step 100, utilize the transmitter 12 shown in FIG. 1 to periodically broadcast a header information packet to the receiver 14.

step 103: when proceeding with step 102 and after utilizing the decoder 16 of the receiver 14 to search the first header from the received data, the decoder 16 of the receiver 14 will neglect the header information packet periodically broadcasted by the transmitter 12 and proceed with step 106.

step 105: when (or before) proceeding with step 104, the receiver 14 will determine the default header from the plurality of previously stored headers according to the header information packet from the transmitter 12 if the decoder 16 of the receiver 14 judges that the first header is not received. The default header will be utilized as the first header, and then the method will proceed with step 106.

Actually, the default header of the present invention is not required to be picked from a plurality of headers previously stored in the receiver 14; that is, the receiver 14 is not required to previously stored a plurality of headers. The default header can be a header utilized in a former decoding operation. In addition, the default header can be picked from a plurality of utilized headers during former decoding operations. No matter how the default header is picked, the characteristic that the default header is utilized to replace the non-received first header for the decoding operation is within the scope of the present invention.

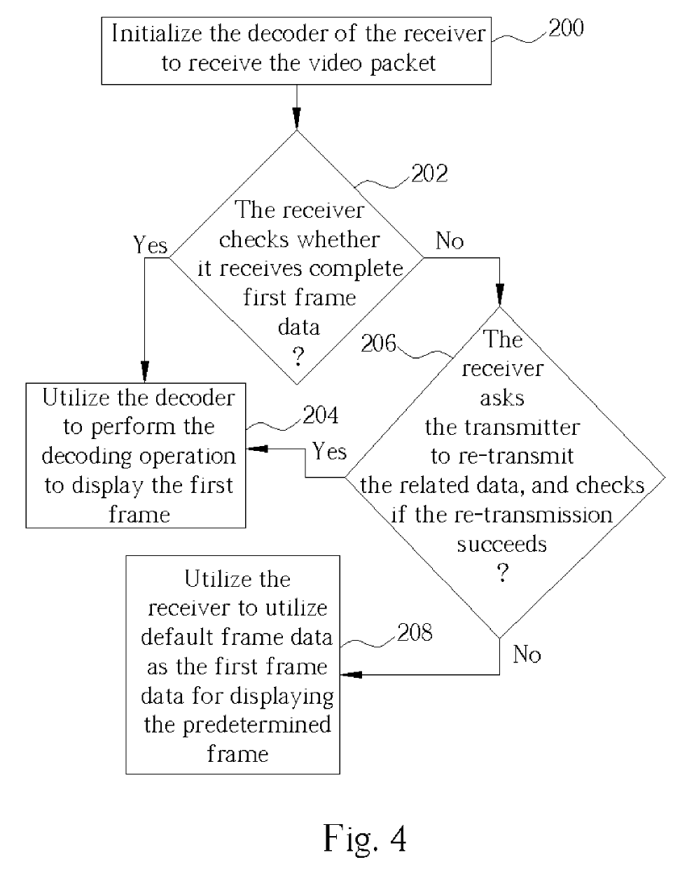

Afterwards, the utilization of the default frame data refers to FIG. 4, which is a flow chart of another method embodiment according to the present invention:

step 200: initialize the decoder 16 of the receiver 14 to receive the video packet (image data) transmitted from the transmitter 12;

step 202: the receiver 14 starts to receive the compressed first frame, and then the receiver 14 will check whether it receives complete first frame data. If the receiver 14 receives the first frame data, proceed with step 204; otherwise, proceed with step 206.

step 204: utilize the decoder 16 of the receiver 14 to perform the decoding operation to display the first frame.

step 206: the receiver 14 will ask the transmitter 12 to re-transmit the related data. When the re-transmission succeeds, proceed with step 204; if the re-transmission fails (for instance, a time-out procedure or exceeding of the maximum data amount occurs), proceed with step 208.

step 208: utilize the receiver 14 to utilize (previously de-compressed) default frame data as the first frame data for displaying the predetermined frame, and the default frame data can be previously stored in the receiver 14.

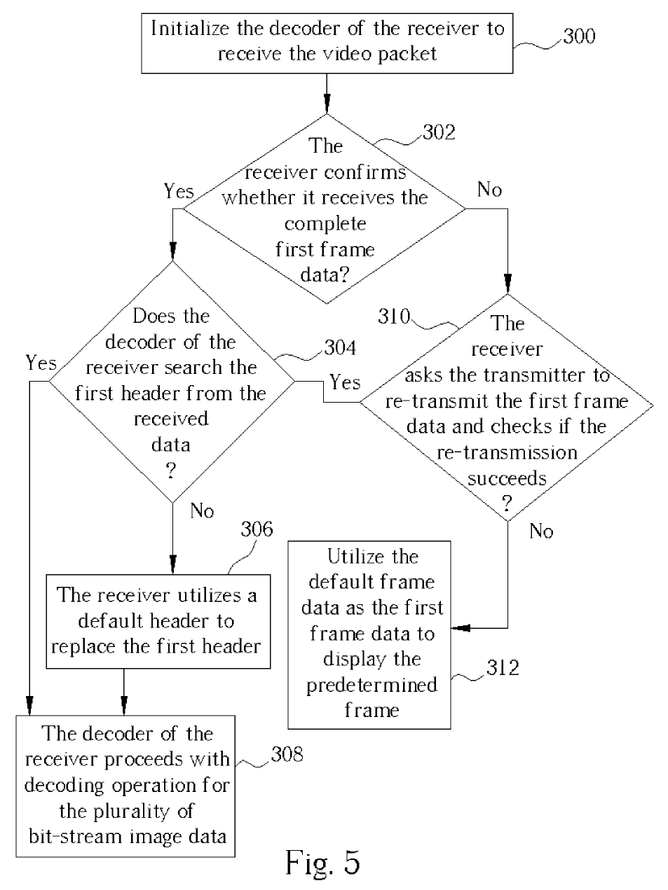

Please notice that the embodiment shown in FIG. 4 can be combined with embodiments shown in FIG. 2 and FIG. 3 to achieve the characteristics of the present invention. Please refer to FIG. 5, which is a flow chart of a detailed method according to the present invention. The operating steps are as follows:

step 300: Initialize the decoder 16 of the receiver 14 to receive the video packet (image data) from the transmitter 12;

step 302: The receiver 14 begins to receive the compressed first frame, and the receiver 14 will confirm whether it receives the complete first frame data. If the receiver 14 receives the first frame data, proceed with step 304; otherwise, proceed with step 310.

step 304: After the receiver 14 starts to receive the first frame, the decoder 16 of the receiver 14 will search the first header from the received data for the de-compressing/decoding operations. If the first header of the first frame data is searched, proceed with step 308; if not, proceed with step 306.

step 306: If the decoder 16 of the receiver 14 judges that the first header is not received, the receiver 14 utilizes a default header to replace the first header, and then the method proceeds with step 308. When being implemented, the transmitter 12 periodically broadcasts a header information packet to the receiver 14. When the decoder 16 of the receiver 14 judges that the first header is not received, the receiver 14 will pick the default header from a plurality of previously stored headers as the first header according to the header information packet transmitted from the transmitter 12.

step 308: If the receiver 14 receives the first header, proceed with the present step directly from step 304, and the decoder 16 of the receiver 14 will neglect the header information packet broadcasted by the transmitter 12 and proceed with decoding operation for the plurality of bit-stream image data according to the received first header to display the first frame; When proceeding with the present step from step 306, the decoder 16 determines the default header and then decodes (displays) the first frame.

step 310: The receiver 14 will ask the transmitter 12 to re-transmit the first frame data. If the re-transmission succeeds, proceed with step 304; if the re-transmission fails, proceed with step 312.

step 312: Utilize the receiver 14 to treat the (previously de-compressed) default frame data as the first frame data to display the predetermined frame, and the default frame data can be previously stored in the receiver 14.

Generally, during wireless transmission, the decoder 16 of the receiver 14 shown in FIG. 1 can perform decoding operations after it receives the complete information; that is, the receiver 14 should operate earlier than the transmitter 12 to receive the data. The present invention utilizes a previously prepared (decoded) predetermined frame as the first frame in the receiver so that the receiver of the present invention does not require operating earlier than the transmitter. Therefore, the receiver of the present invention can operate during the data transmission (initiated by the transmitter). In addition, the present invention also provides a default header as the received first header in the receiver for contingent use so that the present invention can help the wireless transceiver to smoothly operate in deteriorating network surroundings.

Those skilled in the art will readily observe that numerous modifications and alterations of the device and method may be made while retaining the teachings of the invention. Accordingly, the above disclosure should be construed as limited only by the metes and bounds of the appended claims.

1. A method for transmitting signals in a wireless network, the wireless network comprising a receiver for receiving a plurality of image data, the method comprising:
(a) utilizing the receiver to judge whether it receives a first header of the plurality of image data; and
(b) after proceeding with step (a), utilizing the receiver to pick a default header as the first header if the receiver does not receive the first header.

2. The method of claim 1 wherein the wireless network further comprises a transmitter, and a plurality of headers are stored in the receiver; the method further comprising:
(c) utilizing the transmitter to broadcast a header information packet to the receiver; and
(d) in step (b), the receiver picking the default header from the plurality of headers according to content of the header information packet.

3. The method of claim 2 wherein the content of the header information packet is a text string, and the transmitter periodically broadcasts the header information packet to the receiver.

4. The method of claim 1 wherein the receiver comprises a decoder, the method further comprising:
(e) after proceeding with step (a), the decoder decodes the plurality of image data according to the first header if the receiver receives the first header; and
(f) after proceeding with step (b), the decoder decodes the plurality of image data according to the default header.

5. The method of claim 1 wherein the default header is a header utilized in a former operation.

6. The method of claim 1 further comprising:
(g) utilizing the receiver to judge whether it receives a first frame data of the plurality of image data; and
(h) after proceeding with step (g), treating a default frame data as the first frame data if the receiver does not receive the first frame data.

7. The method of claim 1 wherein the plurality of image data conform to an MPEG or a JPEG specification.

8. The method of claim 1 wherein the wireless network is a WPAN, a WLAN, or a WWAN.

9. A method for transmitting signals in a wireless network, the wireless network comprising a receiver for receiving a plurality of image data, the method comprising:
(a) utilizing the receiver to judge whether it receives a first frame data of the plurality of image data; and
(b) after proceeding with step (a), utilizing a default frame data as the first frame data if the receiver does not receive the first frame data.

10. The method of claim 9 wherein the default frame data is previously stored in the receiver.

11. The method of claim 9 further comprising:
(c) utilizing the receiver to judge whether it receives a first header of the plurality of image data; and
(d) after proceeding with step (c), utilizing the receiver to pick a default header as the first header if the receiver does not receive the first header.

12. The method of claim 11 wherein the receiver comprises a decoder, the method further comprising:
(e) after proceeding with step (c), the decoder decoding the plurality of image data according to the first header if the receiver receives the first header; and
(f) after proceeding with step (d), the decoder decoding the plurality of image data according to the default header.

13. The method of claim 11 wherein the wireless network further comprises a transmitter, and a plurality of headers are stored in the receiver, the method further comprising:
(g) utilizing the transmitter to broadcast a header information packet to the receiver; and
(h) in step (d), the receiver picking the default header from the plurality of headers according to content of the header information packet.

14. The method of claim 13 wherein the content of the header information packet is a text string, and the transmitter periodically broadcasts the header information packet to the receiver.

15. The method of claim 11 wherein the default header is a header utilized in a former operation.

16. The method of claim 9 wherein the plurality of image data conform to an MPEG or a JPEG specification.

17. The method of claim 9 wherein the wireless network is a WPAN, a WLAN, or a WWAN.
